(19) United States
(12) Patent Application Publication
(10) Pub. No.: US 2026/0255169 A1
(43) Pub. Date: Aug. 27, 2026

(54) LOW LATENCY, LOW LOSS, SCALABLE THROUGHPUT FOR DISTRIBUTED DENIAL OF SERVICE ATTACK MITIGATION

(71) Applicant: T-Mobile Innovations LLC, Overland Park, KS (US)

(72) Inventor: Timur KOCHIEV, Irvine, CA (US)

(21) Appl. No.: 19/065,208

(22) Filed: Feb. 27, 2025

(51) Int. Cl. H04W 12/122; H04L 9/40; H04L 47/32; H04W 28/02

(52) U.S. Cl. CPC H04W 12/122; H04L 47/32; H04L 63/1416; H04W 28/0284; H04L 2463/143

(57) ABSTRACT

Systems and methods are provided for controlling network congestion caused by malicious attacks. A system comprising a processor is configured by machine-readable instructions to monitor low latency, low loss, scalable throughput (L4S) packets in a wireless network to detect network congestion. The system is further configured to determine the L4S packets satisfy a threshold for L4S packet traffic, and responsive to the L4S packets satisfying the threshold, to identify the L4S packets as malicious traffic. Moreover, the system is configured to adjust the wireless network to prioritize non-malicious traffic in the wireless network.

### TECHNICAL BACKGROUND

A wireless network, such as a cellular network, can include an access node (e.g., wireless access node) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages.

Although 5G RATs boost network capacity and communication speeds, the 5G RATs can experience distributed denial of service (DDoS) attacks when network congestion is artificially and suddenly generated by an overwhelming amount of traffic and by saturating the network buffers. A DDoS attack is a malicious attempt to disrupt the normal functioning of a targeted server, service, or network by creating a flood of internet traffic.

### OVERVIEW

One aspect of the present disclosure relates to a system configured for congestion control in a wireless network. In one implementation, a system comprising one or more hardware processors is configured by machine-readable instructions to: monitor low latency, low loss, scalable throughput (L4S) packets in a wireless network to detect network congestion; determine the L4S packets satisfy a threshold for L4S packet traffic; responsive to the L4S packets satisfying the threshold, identify the L4S packets as malicious traffic; and adjust the wireless network to prioritize non-malicious traffic in the wireless network.

In another implementation, the threshold is determined by an artificial intelligence machine learning (AI/ML) model trained on historical L4S packets for malicious traffic and non-malicious traffic. The AI/ML model may be trained to discern malicious traffic from non-malicious traffic by comparing volumes of L4S data packets, types of the data packets, durations of the network congestion, and/or intensities of the network congestion between historical malicious traffic and non-malicious traffic. The AI/ML model may be trained to discern the DDoS attack from the regular network congestion based on a direction of the detected network congestion.

Further, adjusting the wireless network to prioritize non-malicious traffic may comprise dropping the L4S packets identified as malicious traffic. In addition, identifying the L4S packets as malicious traffic may include identifying a distributed denial of service (DDoS) attack. The instructions may further comprise detecting and dropping the L4S data packets identified as malicious traffic that originate from a DDoS attacking device. The AI/ML model may be trained to apply a network congestion control algorithm to by lowering bitrate of the L4S data packets identified as malicious in the wireless network.

Another aspect of the present disclosure relates to a method for congestion control in a wireless network. The method may include monitoring low latency, low loss, scalable throughput (L4S) packets in a wireless network to detect network congestion; determining the L4S packets satisfy a threshold for L4S packet traffic; responsive to the L4S packets satisfying the threshold, identifying the L4S packets as malicious traffic; and adjusting the wireless network to prioritize non-malicious traffic in the wireless network.

Yet another aspect of the present disclosure relates to a non-transitory computer-readable medium storing instructions of a user equipment (UE) that when executed by a processor cause the processor to perform operations comprising: monitoring low latency, low loss, scalable throughput (L4S) packets in a wireless network to detect network congestion; determining the L4S packets satisfy a threshold for volumetric traffic; responsive to the L4S packets satisfying the threshold, identifying the L4S packets as malicious traffic; and adjusting the wireless network to prioritize non-malicious traffic in the wireless network.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 illustrates an exemplary environment in which a system for wireless communication in accordance with various aspects of the present disclosure is implemented.

FIG. 2 illustrates a congestion control system, in accordance with an embodiment.

FIG. 3 illustrates a method for configuring a wireless network, in accordance with an embodiment.

FIG. 4 illustrates an IP Header, in accordance with an embodiment.

FIG. 5 illustrates an exemplary method for providing network congestion control in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

There are a wide range of applications that rely on real-time communication, interactive experiences, or high-performance data transmission such as online and cloud gaming, video conferencing, AR/VR, and live streaming. Each of these applications can potentially benefit from the use of L4S technology.

DDoS attacks are malicious attempts to disrupt the normal functioning of a wireless network by overwhelming the network with a flood of internet traffic. One of the characteristics of a DDoS attack is that the attack originates from distributed sources. The attack may originate from multiple compromised devices (often forming a botnet), making it harder to mitigate because the traffic comes from many different sources. The targeted system (e.g., device, server, network) is bombarded with excessive requests, exceeding its capacity to handle them, causing slowdowns or complete outages. One of the goals of a DDoS attack may be to make the target system unavailable to legitimate users, that can cause financial, operational, or reputational damage.

Some of the types of DDoS attacks are volume-based attacks, such as user datagram protocol (UDP) flood or internet control message protocol (ICMP) flood, which are designed to overwhelm the bandwidth of the target. Further, DDoS attacks may be protocol attacks, such as synchronize (SYN) flood, or ping of death, which exploit vulnerabilities in network protocols, such as the transmission control protocol (TCP), for example. DDoS attacks can include application layer attacks, that target specific applications (e.g., web servers). DDoS attacks may slow network performance, cause denial of access a website or application, and/or be increased traffic from unusual locations or devices.

In one implementation, mitigation of a DDoS attack is performed through implementation of L4S. The network may be configured in the wireless network to communicate using L4S data packets between an application and user equipment (UE). L4S improves network latency and packet loss by applying optimized congestion control (CC) algorithms for time critical applications.

L4S uses explicit congestion notification (ECN) bit marking in packets to identify network congestion earlier and more precisely than other methods. In embodiments, L4S prioritizes critical services and real network traffic over potentially malicious traffic, maintaining essential network operation even under attack of increased traffic load. Early detection of an attack, such as DDoS, may help network devices to drop packets from malicious sources more efficiently and prioritize non-malicious data packets, improving the overall network resilience. In one example, L4S is monitored across the entire network to help withstand DDoS attacks.

Artificial intelligence (AI) machine learning (ML) algorithm is used to predict DDoS attacks by training using historical network data to understand normal and malicious traffic patterns and by analyzing ECN bit markings when congestion happens over time. For example, a sudden increase in use of ECN marking could alert the system of excessive network traffic growth due to a DDoS attack.

Al/ML models can utilize L4S markings to measure packet loss rates and/or jitter (delay variation) for training and predicting malicious and non-malicious traffic. In some embodiments, anomaly detection methods can be used to prevent DDoS attacks by continuous monitoring of traffic and providing alerts. The detection methods may include outlier detection, clustering, and/or unsupervised learning utilizing L4S markings and network data to identify patterns different from common and legitimate traffic behavior.

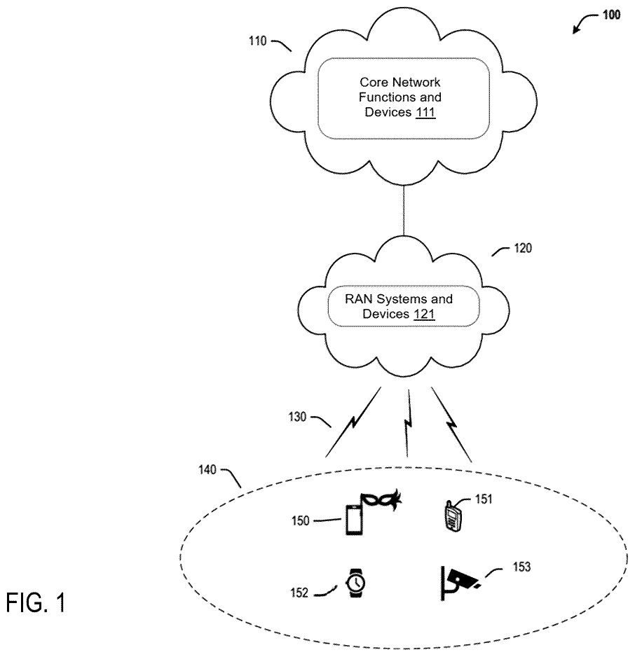

FIG. 1 depicts an exemplary environment 100 in which a system for wireless communication in accordance with the disclosed embodiments is implemented. The environment 100 may include a core network 110, a radio access network (RAN) 120, multiple wireless devices 151-153, and a DDoS attack device 150 able to communicate within the network. While depicted as a single device, as DDoS attacks are often distributed, DDoS attack device can represented multiple DDoS attack devices. The wireless devices 151-153 may be end-user wireless devices and may operate within one or more coverage areas 140 and communicate with the RAN 120 over communication links 130, which may for example be 5G NR communication links, or any other suitable type of communication link.

In one implementation, DDoS device 150 is utilized to disrupt the functioning of the network 110 by overwhelming the network 110 with a flood of internet traffic. The DDoS attack device 150 is utilized to coordinate attacks. The DDoS attacks may be: volume-based attacks, designed to overwhelm the bandwidth of the network; protocol attacks intended to exploit vulnerabilities in network protocols; application layer attacks that target specific applications; or other DDoS attacks executed upon the network 110 and/or devices 151-153.

The core network 110 includes core network functions and devices 111. The core network may be structured using a service-based architecture (SBA). In one implementation, an artificial intelligence (AI) machine learning (ML) model is trained to instruct the network 110 to adjust/modify data packets bit rates based on the network congestion in response to a predicted DDoS attack. The AI/ML model may instruct the network 110 to adjust/modify data packets bitrates and/or drop data packets based on an AI/ML algorithm prediction of DDoS attacks. The AI/ML model may be trained on historical network data to understand normal traffic patterns and malicious traffic patterns by analyzing ECN bit markings when congestion happens over time.

In one implementation, early prediction of a DDoS attack may correspond to applying a threshold of network traffic. Early prediction of malicious traffic by the AI/ML model allows data packet from malicious devices to be dropped or slowed while non-malicious traffic is prioritized.

In one example, the AI/ML model can be trained to distinguish a malicious traffic from non-malicious, by comparing volume, duration, intensity and/or type of packets for regular traffic to the volume, duration, intensity and/or type of packets for known malicious traffic.

Specifically, the AI/ML model can learn the volume, packet type, duration, intensity, and/or other variables of congestion during a naturally occurring congestion and malicious traffic to set thresholds based on degree of deviation from the normal values. Consequently, the AI/ML model can create and analyze signatures malicious traffic and provide alerts to the network and/or devices 151-153 that malicious traffic, such as a DDoS attack, is either taking place or is imminent. In one implementation, the AI/ML model is trained to adjust/modify the bitrate of the data packets from malicious device.

In one implementation, a sudden increase of ECN marking could be an indication to the AI/ML model of excessive network traffic growth and malicious traffic. The AI/ML model can be trained to distinguish non-malicious, normal traffic from malicious traffic. The AI/ML model may utilize outlier detection, clustering, and/or unsupervised learning to identify malicious traffic patterns that are different from non-malicious normal traffic.

The RAN 120 may include various RAN systems and devices 121. The RAN systems and devices 121 are disposed between the core network 110 and the end-user wireless devices 151-153. The DDoS attack device 150 may obtain access to the RAN systems and devices 121. Some of the RAN systems and devices 121 may communicate directly with the core network 110 and others may communicate directly with the end user wireless devices 151-153, in addition to the DDoS attack device 150. Other RAN systems and devices 121 may communicate with one another within the RAN in order to provide services from the core network 110 to the end-user wireless devices 151-153.

The RAN 120 includes at least an access node (or base station), such as an eNodeB, a next generation NodeB (gNodeB) communicating with a plurality of end-user wireless devices. It is understood that the disclosed technology may also be applied to communication between an end-user wireless device and other network resources, such as relay nodes, controller nodes, antennas, etc. Further, multiple access nodes may be utilized. For example, some wireless devices 151-153 may communicate with an LTE eNodeB and others may communicate with an NR gNodeB.

Access nodes can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

The access nodes can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Wireless devices 151-153 may be any device, system, combination of devices, or other such communication platform capable of communicating on the wireless network using one or more frequency bands deployed therefrom. Wireless devices 151-153 may be, for example, mobile phones, wireless phones, cellular home internet modems, personal digital assistants (PDA), tablet computers, as well as other types of devices or systems that can exchange audio or data via the wireless network as non-reduced capability devices, in which some devices may be enhanced Mobile Broadband (eMBB) devices. Further, wireless devices 151-153 may be reduced capability (RedCap) devices and may include smart watches and other wearables, industrial sensors, and video surveillance equipment, for example. Other types of communication platforms are possible.

Environment 100 may further include many components not specifically shown in FIG. 1 including processing nodes, controller nodes, routers, gateways, and physical and/or wireless data links for communicating signals among various network elements. Environment 100 may include one or more of a local area network, a wide area network, and an internetwork (including the Internet). Environment 100 may be capable of communicating signals and carrying data, for example, to support voice, push-to-talk, broadcast video, and data communications by end-user wireless devices 151-153. Wireless network protocols may include one or more of Multimedia Broadcast Multicast Services (MBMS), code division multiple access (CDMA) 1xRTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. the core network functions and devices 111 and RAN 120.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes. This includes but is not limited to core network functions and devices 111 and RAN systems and devices 121.

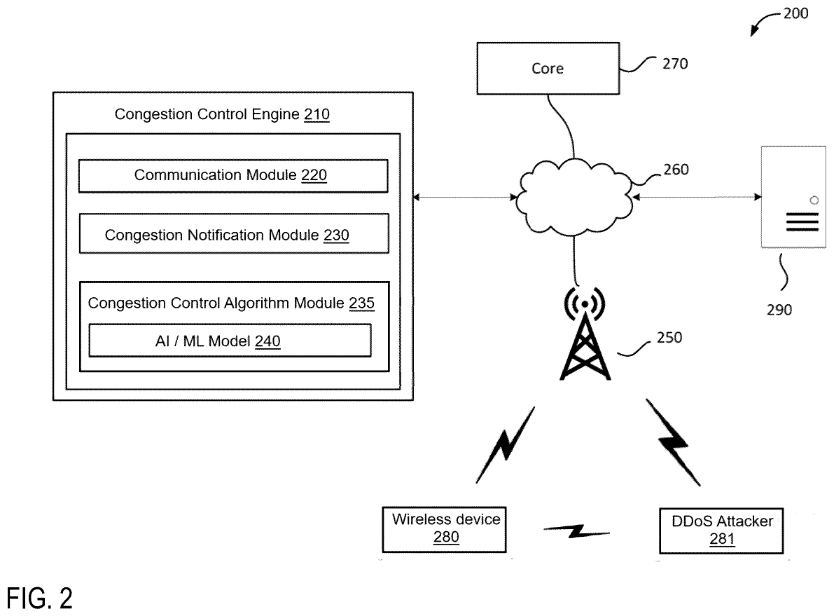

FIG. 2 illustrates a system 200 configured for congestion control, in accordance with one or more implementations. As illustrated, system 200 comprises congestion control engine 210, an access node 250, a network 260, a core 270, which provide service in a coverage area, a host application server 290, and a local network 245. Wireless device 280 and DDoS attack device 281 may have access to the network 260 that communicates with RAN over communication links, which may for example be 5G NR communication links, 4G LTE communication links, or any other suitable type of communication link. For purposes of illustration and ease of explanation, only one access node 250, wireless device 280, DDoS attack device 281 and host application server 290 are shown in the system 200; however, additional access device, nodes and/or application host servers and UEs may be present in the system 200.

In the illustration of FIG. 2, the access node 250 is connected to the network 260 via an NR path (including the 5G core 270). In practical implementations, the access node 250 may be connected to network 260 via multiple paths (e.g., using multiple RATs and/or wired backhaul links). The access node 250 may connect to the network core 270 via wired connections, e.g., fiber, broadband, T1, and microwave relays may be used as well. The access node 250 may communicate with the core 270 via one or more communication links, each of which may be a direct link. However, it will be appreciated that network 260 may be any type of network facilitating communication among congestion control engine 210, access node 250, host application server 290, and core 270.

The access node 250 may be any network node configured to provide communications between the connected wireless devices. As examples of a standard access node, the access node 250 may be a gNodeB in 5G networks. Access node 250 and core 270 may also provide data to congestion control engine 210. The congestion control engine 210 is in communication with the access node 250 and/or the core 270. The congestion control engine 210 may be configured for routing data packets from an application.

The congestion control engine 210 can comprise one or more electronic processors and associated circuitry to execute or direct the execution of computer-readable instructions such as those described herein. In so doing, the congestion control engine 210 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof.

As illustrated, the congestion control engine 210 utilizes a modular controller, a memory, wireless communication circuitry, and a bus through which the various elements of the congestion control engine 210 may communicate with access node 250, core 270, wireless device 280, and host application server 290. The modular controller is one example of an electronic processor, and may include sub-modules or units, each of which may be implemented via dedicated hardware (e.g., circuitry), software modules which are loaded from the memory and processed by the controller, firmware, and the like, or combinations thereof.

While FIG. 2 illustrates communication module 220, congestion notification module 230, and congestion control algorithm module 235 as being separate modules, in practical implementations some of the modules may be combined with one another and/or may share components. The communication module 220, congestion notification module 230, and congestion control algorithm module 235 may be configured to perform various operations to implement methods in accordance with the present disclosure. While one example of operations performed by the modules is described here, in practical implementations at least some of the operations described as being performed by one module may instead be performed by another module, including a module not explicitly named here.

L4S may be an over-the-top method for rate adaptation between a wireless device 280 and a host application server 290. L4S may have a large buffer to have enough time to react to changes in network conditions. L4S enables low latency, high-rate communication with dynamic rate adaptation, even when the wireless network is loaded. L4S provides real-time dynamic rate adaptation algorithms at the application layer. L4S utilizes ECN (Explicit Congestion Notification), Dual Queue Coupled Active Queue Management (AQM), and scalable congestion control algorithms to reduce latency and packet loss.

Communication module 220 communicates data packet types between wireless device 280 as well as DDoS attack device 281, and host application server 290 using a wireless network for a RAN. The application may be an extended reality or gaming application. Congestion notification module 230 may be configured to receive a notification of wireless network congestion for the wireless network. The notification of wireless network congestion may indicate a congestion control threshold has been satisfied for the data packet types. The congestion control engine 210 may apply different congestion control thresholds for regular congestion and for a DDoS caused congestion, as will be discussed in detail below.

In one implementation, in response to the notification from the notification module 230, the network 260 mitigates the congestion by activating congestion control algorithm module 235. The congestion control algorithm module 235 may include an artificial intelligence (AI) machine learning (ML) model 240 that learns data rate mitigation based on historical congestion information. The AI/ML model 240 may instruct the network 260 to adjust/modify data packets bit rates depending on whether an AI/ML algorithm predicts DDoS attacks. The AI/ML model may be trained on historical network data to understand normal traffic patterns and by analyzing ECN bit markings when congestion happens over time.

In one example, the AI/ML model 240 can be trained to predict a DDoS attack from regular congestion by comparing a volume difference of the packets, types of packets used, duration of the attack and/or intensity of the attack, based on the previous DDoS instances. Specifically, the AI/ML model 240 can learn the volume, packet type, timing, duration, intensity, and other variables of congestion during a naturally occurring congestion and during DDoS attacks and establish which of the parameters trigger a DDoS alert and at which degree of deviation from the typical values. The AI/ML model 240 can further incorporate the direction of the traffic into the attack prediction algorithm, for example, whether the direction of the congestion is uplink as opposed to downlink. Consequently, the AI/ML model 240 can create and analyze signature of DDoS attacks used to provide alerts to the network 260 and/or wireless device 280 that the DDoS is occurring or is imminent.

In one implementation, a sudden increase in use of ECN marking could be an indication to the AI/ML model 240 of excessive network traffic growth and potential for a DDoS attack. The AI/ML model 240 can learn L4S features such as packet loss rates and/or jitter for training for normal network congestion as well as for anomalous network congestion. The AI/ML model 240 can be trained to distinguish the normal from anomalous network behavior, i.e., congestion to detect and prevent DDoS attacks by using alerts and continuous monitoring of traffic. Such methods include outlier detection, clustering, and/or unsupervised learning, which can be used to identify patterns different from common and legitimate traffic behavior.

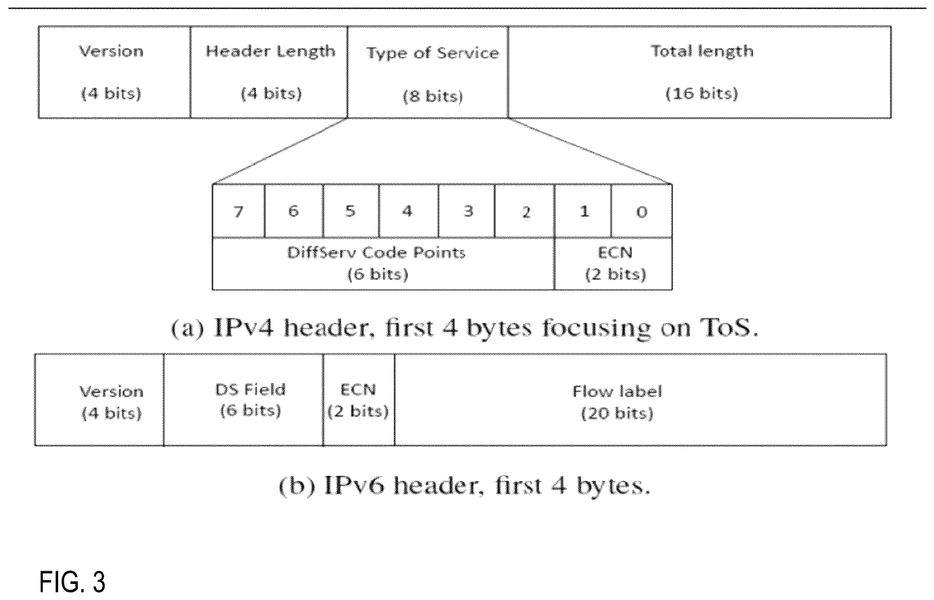

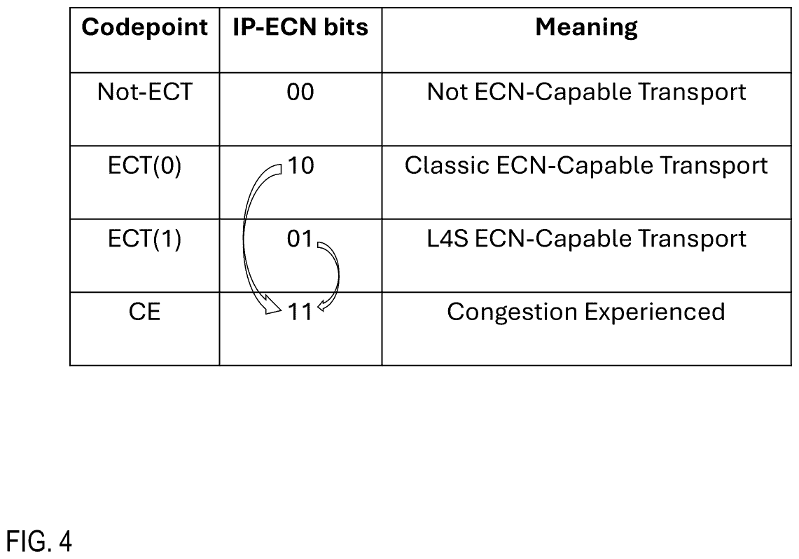

Classic TCP/IP networks signal congestion by dropping packets. ECN aware node sets up a marker in the IP header. A receiver sends a congestion indication to the sender who reduces its transmission rate. However, when using L4S configurations, as shown in FIG. 3 and FIG. 4, the ECT profile allows a host application server to distinguish L4S and classic traffic using an identifier of ECT(1) and Congestion Experienced (CE) codepoints of the ECN field. ECN is defined in RFC3168 (2001) which allows end-to-end (E2E) notification of network congestion without dropping packets.

L4S may use the ECN mechanism to provide early warning of congestion at the bottleneck link by marking a CE codepoint in the IP header of packets. After receiving the packets, the receiver may echo the congestion information to the sender in the acknowledgement (ACK) packets of the transport protocol. The sender may use this congestion feedback to reduce its sending rate to avoid delays at the bottleneck. L4S may further require implementation updates at end devices as well as on the network bottleneck.

For example, wireless device 280 may indicate its L4S capability by setting the ECN-Capable Transport (ECT) codepoint to 01, shown in FIG. 4, known as ECT(1). To confirm that device 280 is L4S capable, the system 200 may look for ECT(1) in the IP header of transmitted packets.

By way of non-limiting example, a congestion control algorithm may be one of Data Center Transmission Control Protocol (DCTCP), Transmission Control Protocol (TCP) Prague, an L4S variant of the RTP Media Congestion Avoidance Techniques (RMCAT) Self-Clocked Rate Adaptation for Multimedia (SCReAM) controller and the L4S ECN part of Bottleneck Bandwidth and Round-trip propagation time version (BBRv2) intended for TCP and Quick UDP Internet Connections (QUIC) Transport.

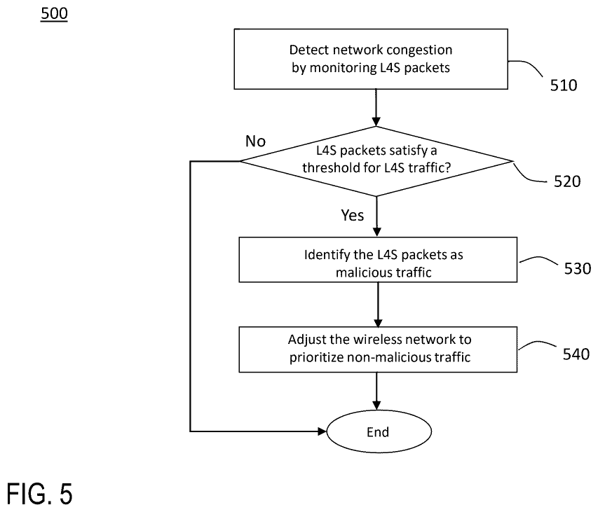

FIG. 5 illustrates an exemplary method 500 for providing network congestion control for malicious attacks. Method 500 starts in step 510, in which the AI/ML model 240 detects network congestion by monitoring L4S packets based on historical behavior of L4S packets during congestion. For example, the AI/ML model 240 stored in the congestion control algorithm module 235 may be trained to detect an increase in the network traffic and based on the historical network behavior, the AI/ML model 240 may predict congestion.

Further in step 520, the system 200 compares marked L4S packets with a threshold for L4S packet traffic. The threshold may be a volumetric threshold, determined by the AI/ML 240 model trained on historical L4S packets for malicious traffic and non-malicious traffic. Moreover, the AI/ML model 240 may be trained to discern malicious traffic from non-malicious traffic by comparing volumes of L4S data packets between historical malicious traffic and non-malicious traffic.

In step 530, responsive to determining that the L4S packets satisfy the threshold, the system 200 identifies the L4S packets as malicious traffic. The AI/ML model 240 may be trained to account for multiple factors when discerning between malicious and non-malicious traffic, such as a volume of L4S data packets, types of the data packets, a duration of the network congestion, an intensity of the network congestion and/or direction of the detected network congestion.

In step 540, the system 200 adjusts the wireless network to prioritize non-malicious traffic. In one implementation, the system 200 prioritizes non-malicious traffic comprises by dropping, blocking and/or slowing the bit rate the L4S packets identified as malicious traffic. In another implementation, the system adjusts by prioritizing L4S packets of non-malicious traffic by assigning them to a priority network slice, changing session configurations, and/or making other changes in the wireless network to prioritize non-malicious traffic. Further, identifying the L4S packets as malicious traffic may include a determination that a distributed denial of service (DDoS) attack is taking place. Accordingly, the system 200 may detect and drop the L4S data packets identified as malicious traffic that originate from a DDoS attacking device. In one implementation, the AI/ML model 240 is trained to apply a network congestion control algorithm by lowering bitrate of the L4S data packets identified as malicious.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system comprising:
one or more hardware processors configured by machine-readable instructions to:
monitor low latency, low loss, scalable throughput (L4S) packets in a wireless network to detect network congestion;
determine the L4S packets satisfy a threshold for L4S packet traffic;
responsive to the L4S packets satisfying the threshold, identify the L4S packets as malicious traffic; and
adjust the wireless network to prioritize non-malicious traffic in the wireless network.

2. The system of claim 1, wherein the threshold is determined by an artificial intelligence machine learning (AI/ML) model trained on historical L4S packets for malicious traffic and non-malicious traffic.

3. The system of claim 2, wherein the AI/ML model is trained to discern malicious traffic from non-malicious traffic by comparing volumes of L4S data packets between historical malicious traffic and non-malicious traffic.

4. The system of claim 2, wherein the AI/ML model is trained to discern malicious traffic from non-malicious traffic by comparing types of data packets between historical malicious traffic and non-malicious traffic.

5. The system of claim 2, wherein the AI/ML model is trained to discern malicious traffic from non-malicious traffic by comparing durations of the network congestion between historical malicious traffic and non-malicious traffic.

6. The system of claim 2, wherein the AI/ML model is trained to discern malicious traffic from non-malicious traffic by comparing intensities of the network congestion between historical malicious traffic and non-malicious traffic.

7. The system of claim 2, wherein the AI/ML model is trained to discern malicious traffic from non-malicious traffic based on a direction of the detected network congestion.

8. The system of claim 1, wherein adjusting the wireless network to prioritize non-malicious traffic comprises dropping the L4S packets identified as malicious traffic.

9. The system of claim 1, wherein identifying the L4S packets as malicious traffic comprises identifying a distributed denial of service (DDoS) attack.

10. The system of claim 9, wherein the instructions further comprise:
detecting and dropping the L4S packets identified as malicious traffic that originate from a DDoS attacking device.

11. The system of claim 2, wherein the AI/ML model is trained to apply a network congestion control algorithm by lowering bitrate of the L4S packets identified as malicious in the wireless network.

12. A method comprising:
monitoring low latency, low loss, scalable throughput (L4S) packets in a wireless network to detect network congestion;
determining the L4S packets satisfy a threshold for L4S packet traffic;
responsive to the L4S packets satisfying the threshold, identifying the L4S packets as malicious traffic; and
adjusting the wireless network to prioritize non-malicious traffic in the wireless network.

13. The method of claim 12, wherein the threshold is determined by an artificial intelligence machine learning (AI/ML) model trained on historical L4S packets for malicious traffic and non-malicious traffic.

14. The method of claim 13, wherein the AI/ML model is trained to discern malicious traffic from non-malicious traffic by comparing volumes of L4S data packets between historical malicious traffic and non-malicious traffic.

15. The method of claim 13, wherein the AI/ML model is trained to discern malicious traffic from non-malicious traffic by comparing types of data packets between historical malicious traffic and non-malicious traffic.

16. The method of claim 13, wherein the AI/ML model is trained to discern malicious traffic from non-malicious traffic by comparing durations of the network congestion between historical malicious traffic and non-malicious traffic.

17. The method of claim 13, wherein the AI/ML model is trained to discern malicious traffic from non-malicious traffic by comparing intensities of the network congestion between historical malicious traffic and non-malicious traffic.

18. The method of claim 12, wherein adjusting the wireless network to prioritize non-malicious traffic comprises dropping the L4S packets identified as malicious traffic.

19. The method of claim 12, wherein identifying the L4S packets as malicious traffic comprises identifying a distributed denial of service (DDoS) attack.

20. A non-transitory computer readable medium storing instructions executed by a processor to perform operations comprising:
monitoring low latency, low loss, scalable throughput (L4S) packets in a wireless network to detect network congestion;
determining the L4S packets satisfy a threshold for L4S packet traffic;
responsive to the L4S packets satisfying the threshold, identifying the L4S packets as malicious traffic; and
adjusting the wireless network to prioritize non-malicious traffic in the wireless network.
